(19) United States
(12) Patent Application Publication
(10) Pub. No.: US 2011/0032340 A1
(43) Pub. Date: Feb. 10, 2011

(54) METHOD FOR CROSSTALK CORRECTION FOR THREE-DIMENSIONAL (3D) PROJECTION

(76) Inventors: William Gibbens Redmann, Glendale, CA (US); Mark J. Huber, Burbank, CA (US); Joshua Pines, San Francisco, CA (US)

Correspondence Address: Robert D. Shedd;THOMSON LICENSING LLC, PATENT OPERATIONS, P.O. BOX 5312, PRINCETON, NJ, 08543-5312, US

(21) Appl. No.: 12/846,676

(22) Filed: Jul. 29, 2010

Related U.S. Application Data
(60) Provisional application No. 61/229,276, filed on Jul. 29, 2009.
(60) Provisional application No. 61/261,732, filed on Nov. 16, 2009.

(51) Int. Cl. H04N 13/04

(52) U.S. Cl. 348/51; 348/E13.075

(57) ABSTRACT

A method for crosstalk compensation of stereoscopic images for three-dimensional projection is disclosed. The method can be used for producing a stereoscopic presentation containing stereoscopic image pairs that incorporate density or brightness adjustments to at least partially compensate for crosstalk contributions from images exhibiting differential distortion.

### CROSS-REFERENCE TO RELATED APPLICATIONS

This application claims priority to U.S. Provisional Application Ser. No. 61/229,276, “Method and System for Crosstalk Correction for 3D Projection” filed on Jul. 29, 2009; and U.S. Provisional Application Ser. No. 61/261,732, “Method and System for Crosstalk Correction for Three-Dimensional (3D) Projection” filed on Nov. 16, 2009; both of which are herein incorporated by reference in their entirety.

### TECHNICAL FIELD

The present invention relates to a method for crosstalk correction for use in three-dimensional (3D) projection and a stereoscopic presentation with crosstalk compensation.

### BACKGROUND

The current wave of 3-dimensional (3D) films is gaining popularity and made possible by the ease of use of 3D digital cinema projection systems. However, the rate of rollout of digital systems is not adequate to keep up with demand, partly because of the relatively high cost involved. Although earlier 3D film systems suffered from various technical difficulties, including mis-configuration, low brightness, and discoloration of the picture, they were considerably less expensive than the digital cinema approach. In the 1980's, a wave of 3D films were shown in the US and elsewhere, making use of a lens and filter designed and patented by Chris Condon (U.S. Pat. No. 4,464,028). Other improvements to Condon were proposed, such as by Lipton in U.S. Pat. No. 5,841,321. Subject matter in both references are herein incorporated by reference in their entirety.

Prior single-projector 3D film systems use a dual lens to simultaneously project left- and right-eye images laid out above and below each other on the same strip of film. These left- and right-eye images are separately encoded (e.g., by distinct polarization or chromatic filters) and projected together onto a screen and are viewed by an audience wearing filter glasses that act as decoders, such that the audience's left eye sees primarily the projected left-eye images, and the right eye sees primarily the projected right-eye images. However, due to imperfection in one or more components in the projection and viewing system, e.g., encoding filters, decoding filters, or other elements such as the projection screen, a certain amount of light for projecting right-eye images can become visible to the audience's left eye, and similarly, a certain amount of light used for projecting left-eye images can become visible to the audience's right eye, resulting in crosstalk. In general, “crosstalk” refers to the phenomenon or behavior of light leakage in a stereoscopic projection system, resulting in a projected image being visible to the wrong eye. Other terminologies used to describe various crosstalk-related parameters include, for example, “crosstalk percent”, which denotes a measurable quantity relating to the light leakage, e.g., expressed as a percentage or fraction, from one eye's image to the other eye's image and which is a characteristic of a display or projection system; and “crosstalk value”, which refers to an amount of crosstalk expressed in an appropriate brightness-related unit, which is an instance of crosstalk specific to a pair of images displayed by a system. Any crosstalk-related parameters can generally be considered crosstalk information.

The binocular disparities that are characteristic of stereoscopic imagery put objects to be viewed by the left- and right-eyes at horizontally different locations on the screen (and the degree of horizontal separation determines the perception of distance). The effect of crosstalk, when combined with a binocular disparity, is that each eye sees a bright image of an object in the correct location on the screen, and a dim image (or dimmer than the other image) of the same object at a slightly offset position, resulting in a visual “echo” or “ghost” of the bright image.

Further, these prior art “over-and-under” 3D projection systems exhibit a differential keystoning distortion between the left- and right-eyes, especially apparent at the top and bottom of the screen. This further modifies the positions of the crosstalking images, beyond merely the binocular disparity.

Not only is the combined effect distracting to audiences, but it can also cause eye-strain, and detracts from the 3D presentation. The crosstalk results because the encoding or decoding filters and other elements (e.g., the screen) do not exhibit ideal properties, e.g., a linear polarizer in a vertical orientation can pass a certain amount of horizontally polarized light, or a screen may depolarize a small fraction of the photons scattering from it.

In present-day stereoscopic digital projection systems, pixels of a projected left-eye image are precisely aligned with pixels of a projected right-eye image because both projected images are being formed on the same digital imager, which is time-domain multiplexed between the left- and right-eye images at a rate sufficiently fast as to minimize the perception of flicker. Crosstalk contribution from a first image to a second image can be compensated for by reducing the luminance of a pixel in the second image by the expected crosstalk from the same pixel in the first image. It is also known that this crosstalk correction can vary chromatically, e.g., to correct a situation in which the projector's blue primary exhibits a different amount of crosstalk than green or red, or spatially, e.g., to correct a situation in which the center of the screen exhibits less crosstalk than the edges.

For example, a technique for crosstalk compensation in digital projection systems is taught in US published patent application US2007/0188602 by Cowan, which subtracts from the image for one eye a fraction of the image for the other eye, where the fraction corresponds to the expected crosstalk (i.e., crosstalk percent). This works in digital cinema (and video) because these systems do not exhibit differential keystone distortion, and the left- and right-eye images overlay each other precisely.

However, for stereoscopic film-based or digital projection systems such as a dual-projector system (two separate projectors for projecting left- and right-images, respectively) or single-projector dual lens system, a different approach has to be used for crosstalk compensation to take into account of differential distortions between the two images of a stereoscopic pair.

### BRIEF DESCRIPTION OF THE DRAWINGS

The teachings of the present invention can be readily understood by considering the following detailed description in conjunction with the accompanying drawings, in which:

FIG. 1 is a drawing of a stereoscopic film projection system using a dual (over-and-under) lens;

FIG. 2 illustrates the projection of left- and right-eye images projected with the stereoscopic film projection system of FIG. 1;

FIG. 3A illustrates a method for compensating for crosstalk in stereoscopic film projection;

FIG. 3B illustrates a spatial relationship among pixels in a projected stereoscopic image pair;

FIG. 4 illustrates an example of the spatial relationship of a projected pixel in one stereoscopic image and proximate pixels in the other stereoscopic image for use in crosstalk calculation;

FIG. 5 illustrates another example of spatial relationship of a projected pixel in one stereoscopic image and proximate pixels in the other stereoscopic image for use in crosstalk calculation;

FIG. 6 illustrates a digital projection system suitable for stereoscopic presentation; and

FIG. 7 illustrates a method for compensating for crosstalk in stereoscopic projection.

To facilitate understanding, identical reference numerals have been used, where possible, to designate identical elements that are common to the figures. The drawings are not to scale, and one or more features may be expanded or reduced for clarity.

### SUMMARY OF THE INVENTION

One aspect of the present invention provides a method suitable for stereoscopic or three-dimensional (3D) projection with a dual-lens single projector system or a dual-projector system. The method can be used for producing a stereoscopic presentation with crosstalk compensation that takes into account of differential distortions between projected images of stereoscopic image pairs.

One embodiment provides a method for producing a stereoscopic presentation containing a plurality of stereoscopic image pairs for projection by a projection system. The method includes: (a) determining distortion information associated with a first and second projected images of a stereoscopic image pair, (b) determining crosstalk percentage for at least one region of the projected images of the stereoscopic image pair, (c) determining a crosstalk value for at least one pixel of the first projected image of the stereoscopic image pair based in part on the determined distortion information and the crosstalk percentage, (d) adjusting brightness of the at least one pixel to at least partially compensate for the crosstalk value, (e) repeating steps (c) and (d) for other pixels in other images in the stereoscopic presentation, and (f) recording the stereoscopic presentation by incorporating images with brightness adjusted pixels.

Another embodiment provides a plurality of stereoscopic images for use in a stereoscopic projection system. The plurality of stereoscopic images include: a first set of images and a second set of images, each image from one of the two sets of images forming a stereoscopic image pair with an associated image from the other of the two sets of images, at least some images in the first set of images incorporating brightness-related adjustments for at least partially compensating for crosstalk contributions from the associated images in the second set of images, at least some images in the second set of images incorporating brightness-related adjustments for at least partially compensating for crosstalk contributions from the associated images in the first set of images. The crosstalk contributions from respective images in the first and second sets of images are determined based in part on distortion information associated with projection of the stereoscopic images.

### DETAILED DESCRIPTION

One aspect of the present invention provides a method for characterizing crosstalk associated with a projection system that also produces differential distortions of projected stereoscopic images, and at least partially compensating for the effect of crosstalk by providing density or brightness adjustments in stereoscopic images in a film or digital file to minimize or reduce the effect of crosstalk. Another aspect of the invention provides a stereoscopic presentation containing a plurality of images that incorporate density or brightness adjustments effective for at least partially compensating for, if not substantially eliminating, crosstalk associated with the projection of stereoscopic images exhibiting differential distortion.

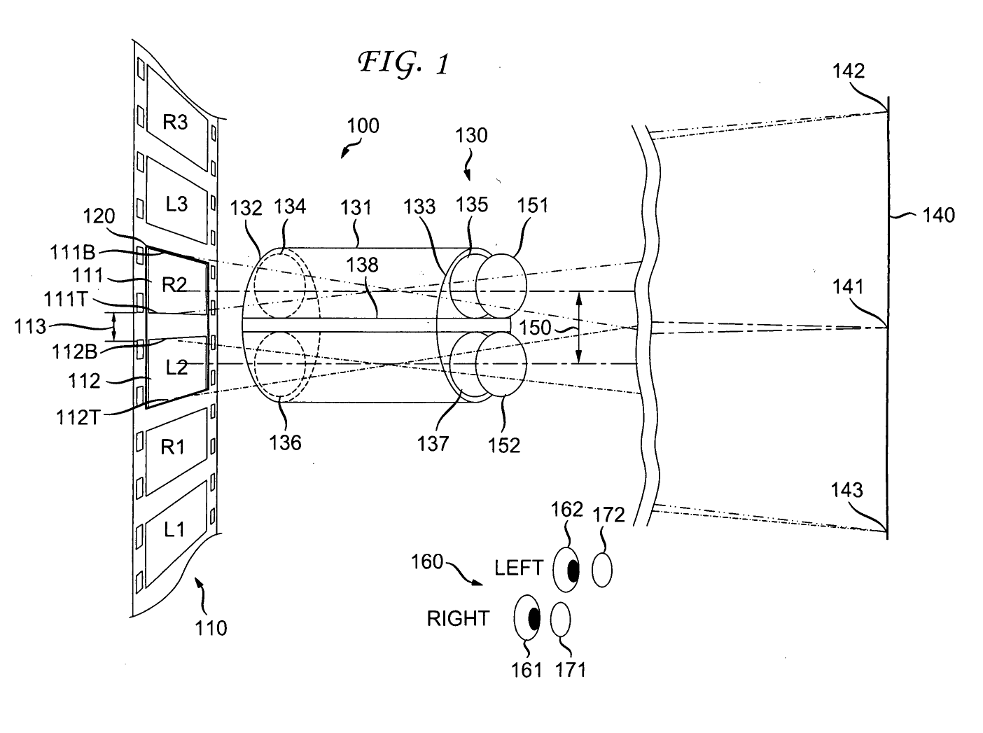

FIG. 1 shows an over/under lens 3D film projection system 100, also called a dual-lens 3D film projection system. Rectangular left-eye image 112 and rectangular right-eye image 111, both on over/under 3D film 110, are simultaneously illuminated by a light source and condenser optics (collectively called the “illuminator”, not shown) located behind the film while framed by aperture plate 120 (of which only the inner edge of the aperture is illustrated, for clarity) such that all other images on film 110 are not visible since they are covered by the portion of the aperture plate which is opaque. The left- and right-eye images (forming a stereoscopic image pair) visible through aperture plate 120 are projected by over/under lens system 130 onto screen 140, generally aligned and superimposed such that the tops of both projected images are aligned at the top edge 142 of the screen viewing area, and the bottoms of the projected images are aligned at the bottom edge 143 of the screen viewing area.

Over/under lens system 130 includes body 131, entrance end 132, and exit end 133. The upper and lower halves of lens system 130, which can be referred to as two lens assemblies, are separated by septum 138, which prevents stray light from crossing between the two lens assemblies. The upper lens assembly, typically associated with right-eye images (i.e., used for projecting right-eye images such as image 111), has entrance lens 134 and exit lens 135. The lower lens assembly, typically associated with left-eye images (i.e., used for projecting left-eye images such as image 112), has entrance lens 136 and exit lens 137. Other lens elements and aperture stops internal to each half of dual lens system 130 are not shown, for clarity's sake. Additional lens elements, e.g., a magnifier following the exit end of dual lens 130, may also be added when appropriate to the proper adjustment of the projection system 100, but are also not shown in FIG. 1. Projection screen 140 has viewing area center point 141 at which the projected images of the two film images 111 and 112 should be centered.

The left- and right-eye images 112 and 111 are projected through left- and right-eye encoding filters 152 and 151 (may also be referred to as projection filters), respectively. To view the stereoscopic images, an audience member 160 wears a pair of glasses with appropriate decoding or viewing filters or shutters such that the audience's right eye 161 is looking through right-eye decoding filter 171, and the left eye 162 is looking through left-eye decoding filter 172. Left-eye encoding filter 152 and left-eye decoding filter 172 are selected and oriented to allow the left eye 162 to see only the projected left-eye images on screen 140, but not the projected right-eye images. Similarly, right-eye encoding filter 151 and right-eye decoding filter 171 are selected and oriented to allow right eye 161 to see only the projected right-eye images on screen 140, but not left-eye images.

Examples of filters suitable for this purpose include linear polarizers, circular polarizers, anaglyphic (e.g., red and blue), and interlaced interference comb filters, among others. Active shutter glasses, e.g., using liquid crystal display (LCD) shutters to alternate between blocking the left or right eye in synchrony with a similarly-timed shutter operating to extinguish the projection of the corresponding film image, are also feasible.

Unfortunately, due to physical or performance-related limitations of filters 151, 152, 171, 172, and in some cases, screen 140 and the geometry of projection system 100, a non-zero amount of crosstalk can exist, in which the projected left-eye images are slightly visible, i.e., faintly or at a relatively low intensity, to the right-eye 161 and the projected right-eye images are slightly visible to the left-eye 162.

This crosstalk, also known as leakage, results in a slight double image for some of the objects in the projected image. This double image is at best distracting and at worst can inhibit the perception of 3D. Its elimination is therefore desirable.

In one embodiment, the filters 151 and 152 are linear polarizers, e.g., an absorbing linear polarizer 151 having vertical orientation placed after exit lens 135, and an absorbing linear polarizer 152 having horizontal orientation placed after exit lens 137. Screen 140 is a polarization preserving projection screen, e.g., a silver screen. Audience's viewing glasses includes a right-eye viewing filter 171 that is a linear polarizer with a vertical axis of polarization, and a left-eye viewing filter 172 that is a linear polarizer with a horizontal axis of polarization (i.e., each viewing filter or polarizer in the glasses has the same polarization orientation as its corresponding filter or polarizer 151 or 152 associated with the respective stereoscopic image). Thus, the right-eye image 111 projected through the top half of dual lens 130 becomes vertically polarized after passing through filter 151, and the vertical polarization is preserved as the projected image is reflected by screen 140. Since the vertically-polarized viewing filter 171 has the same polarization as the projection filter 151 for the right-eye image, the projected right-eye image 111 can be seen by the audience's right-eye 161. However, the projected right-eye image 111 would be substantially blocked by the horizontally-polarized left-eye filter 172 so that the audience's left-eye 162 would not see the projected right-eye image 111. Unfortunately, the performance characteristics of such filters are not always ideal, and crosstalk can result from their non-ideal characteristics.

In this example, the crosstalk percentage (leakage) of the projected right-eye image into the left-eye 162 of audience member 160 is a function of three first-order factors: first, the amount by which right-eye encoding filter 151 transmits horizontally polarized light (where filter 151 is oriented to transmit primarily vertically polarized light); second, the degree to which screen 140 fails to preserve the polarization of light it reflects; and third, the amount by which left-eye decoding filter 172 transmits vertically polarized light used for projecting right-eye images (where filter 172 is oriented to transmit primarily horizontally polarized light).

These factors are measurable physical values or quantities that affect the entire image equally. However, there are variations that can be measured across the screen (e.g., the degree to which polarization is maintained may vary with angle of incidence or viewing angle, or both), or at different wavelengths (e.g., a polarizer may exhibit more transmission of the undesired polarization in the blue portion of the spectrum than in the red). Since the crosstalk arises from one or more components of the projection system, it can be referred to as being associated with the projection system, or with the projection of stereoscopic images.

In some present-day stereoscopic digital projection systems (not shown), pixels of a projected left-eye image are precisely aligned with pixels of a projected right-eye image because both projected images are being formed on the same digital imager, which is time-domain multiplexed between the left- and right-eye images at a rate sufficiently fast as to minimize the perception of flicker. It is known that crosstalk of a first image into a second image can be compensated by reducing the luminance of a pixel in the second image by the expected crosstalk from the same pixel in the first image (see Cowan, op.cit.). When the crosstalk occurs with the expected value, the amount of light leaking in from the projected wrong eye image (e.g., first image) restores substantially the amount of luminance by which the projected corrected eye image (e.g., second image) has been reduced. It is further known that this correction can vary chromatically (e.g., to correct a case where the projector's blue primary exhibits a different amount of crosstalk than green or red) or spatially (e.g., to correct a case where the center of the screen exhibits less crosstalk than the edges). However, these known crosstalk correction methods assume perfect registration between the projected pixels of the left- and right-eye images, which is inadequate for other projection systems such as those addressed in the present invention for which differential distortion is present. In fact, under certain circumstances, applying the known crosstalk correction method to projected stereoscopic images without taking into account the image misalignment arising from differential distortion can exacerbate the adverse effects of crosstalk by making them more visible.

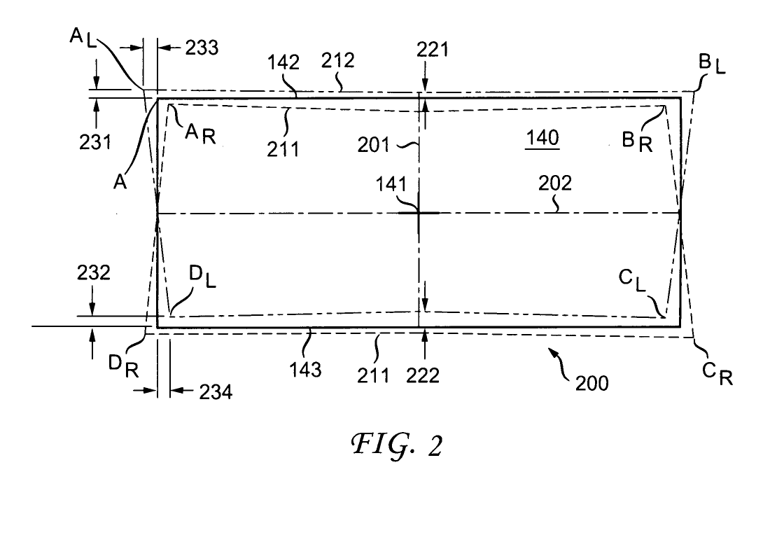

Referring now to FIG. 2, a projected presentation 200 is shown at the viewing portion of projection screen 140, having center point 141, vertical centerline 201, horizontal centerline 202. When properly aligned, the left- and right-eye projected images are horizontally centered about vertical centerline 201 and vertically centered about horizontal centerline 202. The tops of the projected left- and right-eye images are close to the top 142 of the visible screen area, and the bottoms of the projected images are close to the bottom 143 of the visible screen area. In this situation, the boundaries of the resulting projected left- and right-eye image images 112 and 111 are substantially left-eye projected image boundary 212 and right-eye projected image boundary 211, respectively (shown in FIG. 2 with exaggerated differential distortion, for clarity of the following discussion).

Due to the nature of lens 130, the images 111 and 112 are inverted when projected onto screen 140. Thus, the bottom 112B of left-eye image 112 (close to the center of the opening in aperture plate 120) is projected toward the bottom edge 143 of the visible portion of projection screen 140. Similarly, the top 111T of right-eye image 111 (close to the center of the opening in aperture plate 120) is projected toward the top edge 142 of the visible portion of screen 140. On the other hand, the top 112T of left-eye image 112 is projected near the top edge 142, and the bottom 111B of right-eye image 111 is projected near the bottom edge 143 of the visible portion of projection screen 140.

Also shown in FIG. 2 is the presence of differential distortion, i.e., different geometric distortions between the two projected right-eye and left-eye images. The differential distortion arises from differing projection geometries for the right- and left-eye images. In this example, the projected right-eye image is represented by a slightly distorted quadrilateral with boundary 211 and corners A_{R}, B_{R}, C_{R} and D_{R}; and the left-eye image is represented by a slightly distorted quadrilateral with boundary 212 and corners A_{L}, B_{L}, C_{L} and D_{L}.

The right-eye image boundary 211 and left-eye image boundary 212 are illustrative of a system alignment in which differential keystone distortions of the projected stereoscopic images are horizontally symmetrical about vertical centerline 201 and the differential keystone distortions of the left-eye are vertically symmetrical with those of the right-eye about horizontal centerline 202. The keystoning distortions result primarily because right-eye image 111 is projected by the top half of dual lens 130, which is located further away from the bottom edge 143 of the viewing area (or projected image area) than the lower half of dual lens 130. The slightly increased distance for the top half of lens 130 to the screen compared with the lower half of lens 130 results in a slight increase in magnification for the projected right-eye image compared to the left-eye image, as evident by a longer bottom edge D_{R}C_{R} of projected right-eye image 211 compared to the bottom edge D_{L}C_{L} of the projected left-eye image 212. On the other hand, the top half of dual lens 130 is closer to the top edge 142 of the viewing area than the lower half of lens 130. Thus, the top edge A_{R}B_{R} of projected right-eye image 211 is shorter than the top edge A_{L}B_{L} of the projected left-eye image 212.

Near the top-left corner of screen 140, left-eye projected image boundary 212 has horizontal magnification keystone error 233 (representing horizontal distance between corner A_{L} and corner A, which is where A_{L} would be in the absence of keystone distortion) and vertical magnification keystone error 231. When symmetrically aligned, similar errors are found at the top-right corner of screen 140. Near the bottom-left corner of screen 140, left-eye projected image boundary 212 has horizontal demagnification keystone error 234, and vertical demagnification keystone error 232.

Besides just differential keystoning, additional differential distortions may be present, for example a differential pincushion distortion, where vertical magnification error 221 at the center-top of projected right-eye image 212 with respect to the top 142 of screen 140 may not be not the same as vertical magnification keystone error 231 in the corner. Similarly, vertical demagnification error 222 at the center-bottom of projected right-eye image 212 may not be the same as vertical demagnification error 232. (In this example, additional horizontal distortions are not shown, for brevity.)

As discussed below, the differential distortion between the right- and left-eye images will need to be taken into account for determining crosstalk contributions from pixels of a first-eye's image to the second-eye's image.

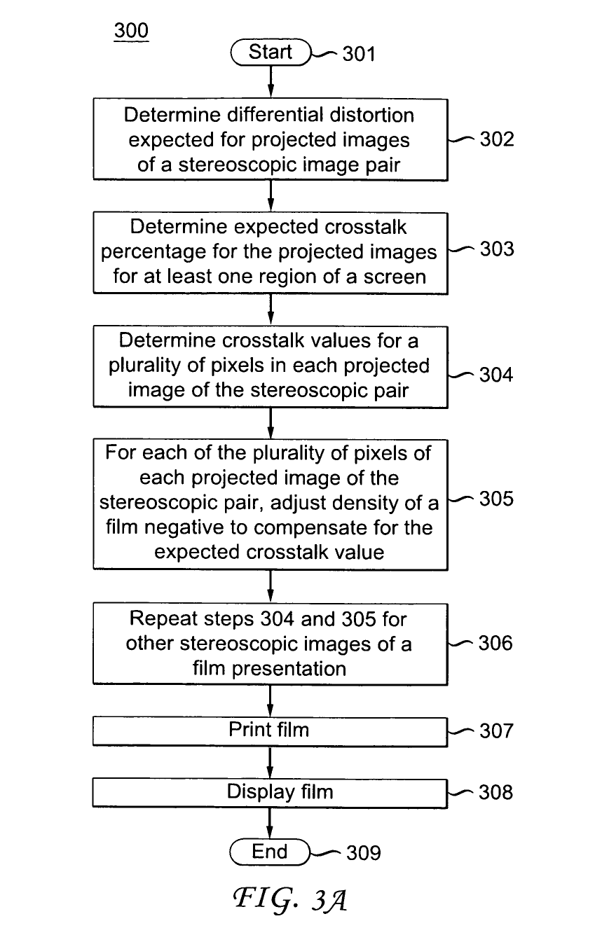

FIG. 3A shows a process 300 for producing a stereoscopic film or presentation having a plurality of stereoscopic images with correction for the expected crosstalk between left- and right-eye projected images. The expected crosstalk refers to the crosstalk values that one would observe between the left- and right-eye images of a stereoscopic pair when projected in a given projection system. In step 301, the theatre in which the resulting film is to be projected, e.g., using a dual-lens projection system such as system 100 or a dual-projector system, is selected. If the film is being prepared for a number of theatres with similar projection systems, then these theatres can be identified or representative ones chosen for the purpose of distortion and/or crosstalk determination, as explained below.

### Step 302

In step 302, expected differential distortion between left- and right-eye images of a stereoscopic pair to be projected in the selected theatre or system, is determined by either measurement, modeling, or estimation. The differential distortion refers to a difference in distortion observed between projected first and second images of a stereoscopic image pair arising from one or more distortions from the projection system, e.g., keystoning, pin cushion, among others, and may be expressed in terms of a difference in the locations of pixels as they appear in the projected left- and right-images. The differential distortion can also be referred to as being associated with projection of the stereoscopic images. In step 302, instead of measuring the differential distortion of the left- and right-eye images with respect to each other, distortions of both images can also be measured with respect to a common reference, e.g., the screen. Images for distortion measurements can be provided as a film loop, and the images do not have to be actual images in a stereoscopic film or movie presentation.

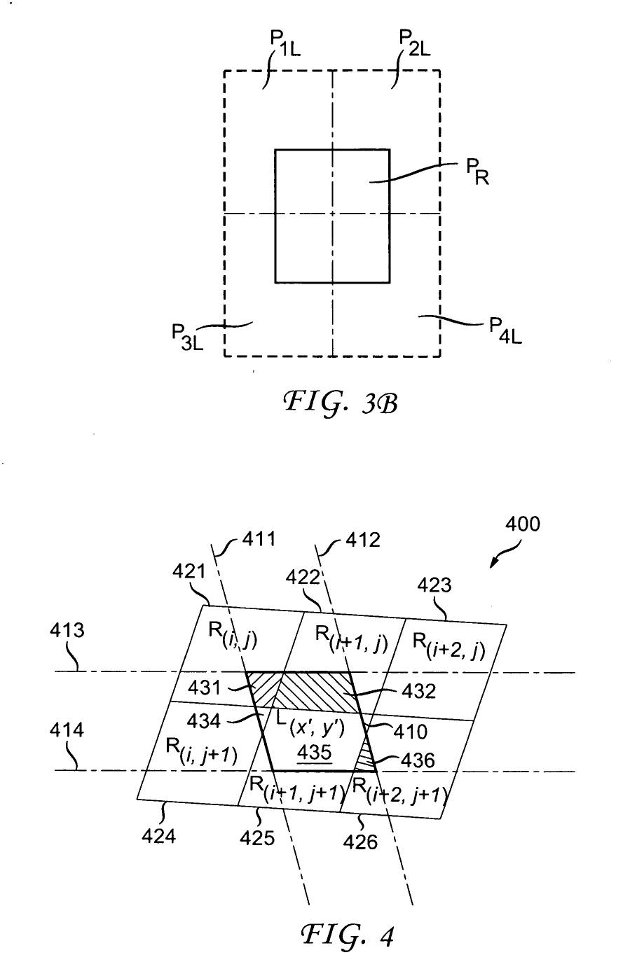

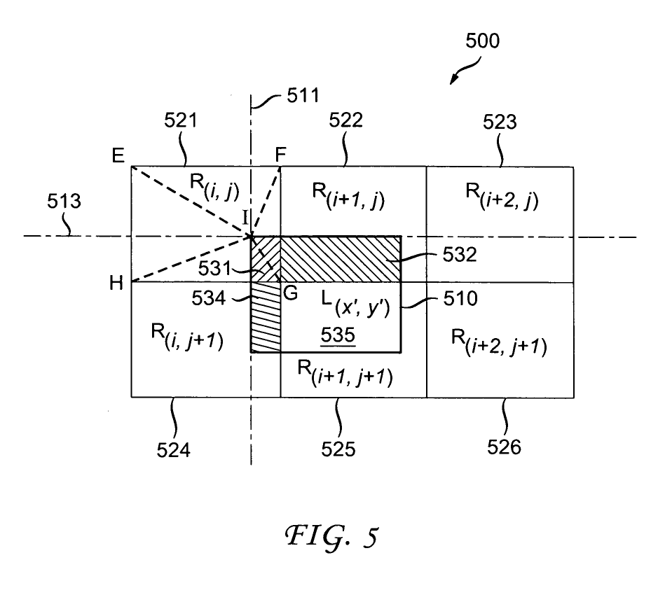

In one example, a test pattern (not shown) with fiducial markings for coordinates in each of the left- and right-eye projected images 212 and 211 can be used to provide a cross-reference between the coordinates of one eye's image to the coordinates of the other eye's image, e.g., by examining the projection, a common point on the screen could be located in coordinates for both the left- and right-eye's image. In this way, a correspondence between a pixel in the left-eye image and the one or more pixels in the right-eye image that are expected to contribute to crosstalk (i.e., produce crosstalk contributions) in the left-eye image pixel is established. This correspondence is discussed in further detail in conjunction with FIGS. 4 and 5.

In another embodiment of step 302, the distortion can be obtained by estimating the amount by which the corresponding corners of projected left- and right-eye images 211 and 212 are mismatched. For example, the top-left corner A_{L} of projected image 212 is further left and higher than the top-left corner A_{R} of projected image 211, say by 2 inches horizontally and 1 inch vertically, which, for a 40-foot screen might represent about 8 pixels horizontally and 4 pixels vertically (assuming the projected image is about 2000 pixels wide and no anamorphic projection is used). In a case where the differential distortion is substantially symmetrical e.g., symmetrical about the vertical centerline 201, then this single corner may be sufficient to describe geometry of the two trapezoidal boundaries of projected images 211 and 212 so as to allow coordinates in one image to be transformed to or correlated with coordinates in the other image. For example, if the differential distortions is symmetrical about the vertical centerline 201, for a given eye's image, a pixel at a given height and offset to the left of the centerline 201 would have the same magnitude of distortion as a pixel (at the same height) with the same amount of offset to the right of centerline 201. In this case (the simple on-axis case illustrated in FIGS. 1-2), neglecting any pin cushion or barrel distortion, differential distortions of the projected left-eye and left-eye images will also be mirror images of each other with respect to the horizontal centerline 202, i.e., if the left-eye image is flipped vertically about the horizontal centerline 202, it will overlap the projected right-eye image.

For example, if the top-left corner A_{R} of projected right-eye image 211 has right-eye image coordinate {0,0} and the bottom-right corner C_{R} is {2000,1000}, then the observed mismatch between the corners A_{R} and A_{L} (i.e., horizontal separation of 8 pixels and vertical separation of 4 pixels) would indicate that the top-left corner A_{R} of projected right-eye image 211 corresponds to a coordinate of {8,4} in the coordinate space of left-eye image 212, and the bottom-right corner C_{R} of right-eye image 211 corresponds to a coordinate of {2008,1004} in the coordinate space of left-eye image 212, even if those coordinates are outside the bounds of projected image 212.

Similarly, the bottom-right corner C_{L} of left-eye image 212 would be found corresponding to coordinates of about {1992,996} in the right-eye image, while the top-left corner A_{L} of projected left-eye image 212 would be corresponding to a coordinate of about {−8,−4} in the coordinates of the right-eye image, even if that is outside the bounds of projected right-eye image 211. If projection system 100 is symmetrically aligned, the center 141 of screen 140 would correspond to the coordinate {1000,500} in the coordinate spaces of both the projected left- and right-eye images 212 and 211. Examples of several locations in the left-eye image and the corresponding coordinates in the left-eye and right eye coordinate spaces are given in Table 1 (in which “center” refers to midpoint between top and bottom, and “middle” refers to midpoint between left and right).

TABLE 1

| Location in Left-Eye | In Left-Eye | In Right-Eye |
|---|---|---|
| Image | Coordinates | Coordinates |
| Top-Left corner | {0, 0} | {−8, −4} |
| Top-Middle | {1000, 0} | {1000, −4} |
| Top-Right corner | {2000, 0} | {2008, −4} |
| Center-Left | {0, 500} | {0, 500} |
| Center-Middle | {1000, 500} | {1000, 500} |
| Center-Right | {2000, 500} | {2000, 500} |
| Bottom-Left corner | {0, 1000} | {8, 996} |
| Bottom-Middle | {1000, 1000} | {1000, 996} |
| Bottom-Right corner | {2000, 1000} | {1992, 996} |

Based on these coordinate values, the coordinates of other locations in the left-eye image can be obtained, e.g., by interpolation, using formulae that best fit the nature of the distortion. For example, for the simple perspective (trapezoidal) distortions discussed above, the following equation can be used to translate an left-eye image coordinate {x_{L},y_{L}} into right-eye image coordinates {x_{R},y_{R}}.

x_{R}=x_{L}−8[(y_{L}−y_{C})/y_{C}]*[(x_{L}−x_{C})/x_{C}]

y_{R}=y_{L}−4(y_{L}−y_{C})²/y_{C}² EQ. 1:

where {x_{C},y_{C}} is the center point {1000,500}.

The reverse transformation from {x_{R},y_{R}} to {x_{L},y_{L}}, to within a small fraction of a pixel, is given by EQ. 2:

x_{L}=x_{R}+8[(y_{R}−y_{C})/y_{C}]*[(x_{R}−x_{C})/x_{C}]

y_{L}=i_{R}+4(y_{R}−y_{C})²/y_{C}²

### Step 303

In step 303, the crosstalk percentage expected for left- and right-eye images of a stereoscopic pair projected by the system in the selected theatre can be directly measured or estimated at one or more regions of a screen (corresponding to projected image space). If the crosstalk is expected or known not to vary significantly across the projection screen, then crosstalk determination at one region would be sufficient. Otherwise, such determination will be done for additional regions. What is considered as a significant variation will depend on the specific performance requirement based on business decision or policy.

In one embodiment, the crosstalk percentage is measured by determining the amount of a stereoscopic image (i.e., the light for projecting the image) that leaks through a glasses' viewing filter for the other stereoscopic image. This can be done, for example, by running a blank (transparent) film through projection system 100, blocking one output lens, e.g. covering left-eye output lens 137 with an opaque material, and measuring the amount of light at a first location or region of the screen 140, e.g., center 141, as seen from the position of audience member 160 through the right-eye filter 171. This first measurement can be referred to as the bright image measurement. Although an open frame (i.e., no film) can be used instead of a transparent film, it is not preferred because certain filter components, e.g., polarizers, may be vulnerable to high illumination or radiation flux. A similar measurement, also with the left-eye output still blocked, is performed through the left-eye filter 172, and can be referred to as the dim image measurement.

These two measurements may be made with a spot photometer directed at point 141 through each of viewing filters 171 and 172, respectively. A typical measurement field of about one or two degrees can be achieved. For these measurements, the respective filters 171 and 172 should be aligned along the optical axis of the photometer, and positioned with respect to the photometer in similar spatial relationship as between the viewing glass filters and the audience's left- and right-eyes 162 and 161. The ratio of the dim image measurement to the bright image measurement is the leakage, or crosstalk percentage. Optionally, additional measurements can be done at other audience locations, and the results (the ratios obtained) of a specific screen region can be averaged (weighted average, if needed).

If desired, similar measurements may be made for other locations or regions on the screen by directing the photometer at those points. As will be discussed below, these measurements for different screen locations can be used for determining crosstalk values associated with pixels in different regions of the screen. Furthermore, if the photometer has spectral sensitivity, i.e., capable of measuring brightness as a function of wavelength, the crosstalk can be assessed for discoloration (e.g., whether the crosstalk is higher in the blue portion of the spectrum than in the green or red) so that a separate crosstalk percentage may be determined for each color dye in the print film.

In another embodiment, the crosstalk percentage may be directly observed, e.g., by providing respective test content or patterns for the left- and right-eye images. As an example, a pattern having a density gradient (not shown) with values ranging from 0% transparency to 20% transparency (i.e., from maximum density to a lower density admitting light representative of at least the worst-expected-case for crosstalk, which may be different from 20% in other examples) can be provided in the left-eye image 112, and a pattern (not shown) in the right-eye image 111 is provided at 100% transparency, i.e., minimum density. To determine the crosstalk percentage from the right-eye image to the left-eye image, an observer could visually determine, by looking at the test content only with left-eye 162 through the left-eye filter 172, which gradient value best matches the apparent intensity of right-eye pattern leaking through the left-eye filter 172.

The left-eye pattern may be a solid or checkerboard pattern projected at the top half of the screen, with a density gradient that provides a 0% transparency (i.e., black) on the left, to 20% transparency on the right (e.g., with black squares in the checkerboard always black, but the ‘bright’ or non-black squares ranging from 0% to 20% transparency). The right-eye pattern may also be a solid or checkerboard pattern projected at the lower half of the screen (e.g., with bright squares of the checkerboard being at a minimum density, i.e., full, 100% brightness). The observer, viewing through the left-eye filter only, may note where, from left to right, the pattern across the top half of the screen (the left-eye image), matches intensity with the pattern at the bottom half of the screen (the right-eye image), that is, where the leakage of the bottom pattern best matches the gradient at the top of the screen.

Using separate color test patterns, a separate crosstalk percentage may be obtained for each of the cyan, yellow, and magenta dyes of print film 110.

In still another embodiment of step 303, the crosstalk percentage may be estimated from the specifications of the materials or components (e.g., filters and screen). For example, if right-eye filter 151 is known to pass 95% of vertically polarized light and 2% of horizontally polarized light, that would represent about 2.1% (0.02/0.95) leakage into the left-eye 162. If screen 140 is a silver screen and preserves polarization on 94% of reflected light, but disrupts polarization for the remaining 5%, that would represent an additional 5.3% of leakage (0.05/0.94) into either eye. If left-eye horizontal polarizing filter 172 passes 95% of horizontally polarized light, but allows 2% of vertically polarized light to pass, then that is another 2.1% of leakage. Together, these different leakage contributions will add (in the first order) to about 9.5% of leakage resulting in an overall crosstalk percentage, i.e., the fraction of light from the right-eye image observed by the left-eye.

### CALC1:

$$\frac{0.02}{0.95} + \frac{0.05}{0.94} + \frac{0.02}{0.95} = 0.0953$$

If a higher accuracy is required, a more detailed, higher-order calculation can be used, which takes into account the light leakage or polarization change at each element in the optical path, e.g., passage of the wrong polarization through a polarizing filter element or polarization change by the screen. In one example, a complete higher-order calculation of the crosstalk percentage from the right-eye image to the left-eye image can be represented by:

### CALC2:

$$\frac{( \begin{matrix}0.95 * \\ 0.94 * \\ 0.02\end{matrix} ) + ( \begin{matrix}0.95 * \\ 0.05 * \\ 0.95\end{matrix} ) + ( \begin{matrix}0.02 * \\ 0.94 * \\ 0.95\end{matrix} ) + ( \begin{matrix}0.02 * \\ 0.05 * \\ 0.02\end{matrix} )}{( \begin{matrix}0.95 * \\ 0.94 * \\ 0.95\end{matrix} ) + ( \begin{matrix}0.95 * \\ 0.05 * \\ 0.02\end{matrix} ) + ( \begin{matrix}0.02 * \\ 0.94 * \\ 0.02\end{matrix} ) + ( \begin{matrix}0.02 * \\ 0.05 * \\ 0.95\end{matrix} )} = 9.484 \% \qquad$$

In the above expression, each term enclosed in parentheses in the numerator represents a leakage term or leakage contribution to an incorrect image (i.e., light from a first image of the stereoscopic pair passing through the viewing filter of the second image, and being seen by the wrong eye) arising from an element in the optical path, e.g., projection filters, screen and viewing filters. Each term enclosed in parentheses in the denominator represents a leakage that actually contributes light to the correct image.

In this context, each leakage refers to each time that light associated with a stereoscopic image is transmitted or reflected with an “incorrect” (or un-intended) polarization orientation due to a non-ideal performance characteristic of an element (e.g., a filter designed to be a vertical polarizer passing a small amount of horizontally polarized light, or a polarization-preserving screen resulting in a small amount of polarization change).

In the above expression of CALC2, terms representing an odd number of leaks (one or three) appear in the numerator as leakage contributions, whereas terms containing an even number of ‘leaks’ (zero or two) appear in the denominator as contributing to the correct image.

The latter contribution to the correct image can arise, for example, when a fraction of incorrectly polarized light (e.g., passed by an imperfect polarizing filter) changes polarization upon being reflected off the screen (which should have preserved polarization), and results in the leakage being viewed by the correct eye.

For example, the third term in the numerator of CALC2 represents the fraction of the leakage caused by right-eye image projection filter 151 (2%) remains unchanged by screen 140 (94%) and passed by left-eye viewing filter 172 (95%). The fourth term in the denominator represents light leakage contribution to the correct image when horizontally-polarized light leaked by filter 151 has its polarization changed by screen 140 back to vertical polarization, thus resulting in leakages contributing to the correct image when passed by vertical polarizing filter 171.

However, the more detailed calculation of CALC2 usually results in a value only slightly different than the simpler estimate from the first order calculation (CALC1), and thus, the simpler calculation is adequate in most cases.

From the foregoing, other techniques for measuring, calculating, or estimating the crosstalk percentage will be apparent to those skilled in the art.

### Step 304

In step 304, the crosstalk values for a plurality of pixels in the projected images of the stereoscopic pair for one frame of the film or movie presentation, e.g., images 111 and 112 in FIG. 1, are determined (can be referred to as “pixel-wise” crosstalk value determination). As explained below, the crosstalk value for a given pixel in a first-eye image is determined from crosstalk contributions expected from proximate pixels of the second-eye image, with the proximate pixels being identified based on distortion information from step 302. In the context of crosstalk correction for a film, the use of the term “pixel” refers to that of a digital intermediate, i.e., a digitized version of the film, which, as one skilled in the art recognizes, is typically how film editing in post-production is done these days. Alternatively, the pixel can also be used in reference to the projected image space, e.g., corresponding to a location on the screen.

In one embodiment, it is assumed that crosstalk value determination and/or correction is desired or needed for all pixels in the left- and right-eye images. Thus, crosstalk values will be determined for all pixels in both the left- and right-eye images. In other embodiments, however, determination of crosstalk values may be performed only for some pixels in each of the stereoscopic images, e.g., if it is known or decided that crosstalk compensation is not needed for certain pixels or portions of either of the images.

For a given pixel in a first-eye image under consideration, one or more pixels of the second-eye image that are projected proximate to the projection of the given pixel are identified, and the contribution from each of the proximate pixels (of the other-eye image) to the total crosstalk value of the given pixel is determined. For example, based on results from step 302 (which determines the differential distortion between a stereoscopic image pair), pixels from the left- and right-eye images can be converted to a common coordinate system, e.g., from the coordinate system of one image to the other image's system, e.g., using EQ. 1 or EQ. 2, so that correspondence can be established among pixels from the two images and the crosstalk-contributing or proximate pixels (from the second-eye image) associated with the given pixel of the first-eye image can be identified.

This is illustrated in FIG. 3B, which shows the spatial relationship between a pixel under consideration in a first image and several pixels from the other eye's image (for which crosstalk contributions from the other eye's image to the pixel under consideration are to be determined). In this example, projected pixel P_{R} of the right-eye image is proximate to the projected pixels P_{1L}, P_{2L}, P_{3L} and P_{4L} (dotted rectangles) of the left-eye image, and these proximate pixels from the left-eye image are expected to contribute to the crosstalk value at pixel P_{R}. Each of these proximate pixels from the left-eye image is further characterized by its relative contribution to the crosstalk value at pixel P_{R}. Note that in the absence of differential distortion, pixels in the right- and left-eye images will have a one-to-one correspondence, and will overlap each other. In the presence of differential distortion, there will, in general, be a plurality of proximate pixels (e.g., at least two) from one image contributing non-zero crosstalk to a given pixel in the other image.

In this example, there are four pixels from the second-eye image considered proximate to a pixel of the first-eye image, and they contribute equal proportions to the crosstalk of the first eye's image, then the contribution of each will be 25%. If the crosstalk percentage determined for this region of the image in step 303 is X_{T} (crosstalk percentage, expressed as a percentage or fraction), then the crosstalk value (P_{R}_{_{X}}) for the pixel under consideration (e.g., pixel P_{R} in right-eye image) is X_{T} times the sum of the products of (P_{iL}_{ᵥ}) and c(P_{iL},P_{R}), where P_{iL}_{ᵥ} is the value of each proximate other-eye pixel, e.g., left-eye image pixel P_{iL}, (where i is the index for each proximate left-eye pixel, e.g., i=1 to 4 in FIG. 3B) and c(P_{iL},P_{R}) is the crosstalk contribution to pixel P_{R} from pixel P_{iL} (each being equal to 25% in this example) as shown in Equation 3.

$${P}_{{R}_{X}} = {X}_{T} {\sum }_{i} ( {P}_{{iL}_{V}} * c ( {P}_{iL} , {P}_{R} ) ) \qquad EQ . 3$$

where

P_{R}_{_{X}}=crosstalk(P_{R})

P_{iL}_{ᵥ}=value(P_{iL})

c(P_{iL},P_{R})=contribution(P_{iL},P_{R})

As used in this discussion, the “value” of a pixel refers to representation of one or more of a pixel's properties, which can be, for example, brightness or luminance, and perhaps color. c(P_{iL},P_{R}) represents the fraction of pixel P_{R} that is overlaid by a proximal pixel P_{iL}, e.g., from 0-100%. The product of P_{iL}_{ᵥ} and c(P_{iL},P_{R}) can be referred to as a “crosstalk contribution value” from the proximate pixel P_{iL}. For example, if a proximal pixel P_{iL} of 50 brightness units (a linear unit) overlaps 20% of the pixel of interest P_{R}, then 20%*50=10 brightness units would be the crosstalk value contributed by the proximal pixel P_{iL} to the pixel P_{R} of the other eye image.

When the sum of these crosstalk contribution values from all proximate pixels P_{iL} is multiplied by X_{T}, the crosstalk percentage in this region (e.g., measured or estimated in step 303), the result of P_{R}_{_{X}} is the total crosstalk value for pixel P_{R}, e.g., corresponding to the total extra brightness observed for the pixel P_{R} resulting from crosstalk or light leakage from the other eye's image. It is this crosstalk value for which compensation is needed for pixel P_{R}, in order to reduce the extra brightness that would otherwise be observed at pixel P_{R}.

If the crosstalk percentage X_{T} is determined only for one region of an image, e.g., no spatial variation is expected across the screen, then this quantity can be used in EQ. 3 for computing the crosstalk value for all pixels of that image.

However, if the crosstalk percentage determined in step 303 varies across the screen 140 (i.e., different measurements for different regions), then this variation is taken into account in step 304. For example, if the pixel under consideration is located between two regions with different crosstalk percentages, the value of X_{T} may be obtained by interpolation. If the crosstalk percentage determined in step 303 varies with each of the cyan, yellow, and magenta print dyes, this variation is also taken into account in this step, e.g., separate crosstalk percentage for the respective print dye colors: X_{C}, X_{Y}, X_{M} (expressed as percentages).

Note that for these computations, other-eye pixel values must be linear values. Thus, if the pixel values represent a logarithmic value, this must first be converted into a linear representation before being manipulated in the above computation. The crosstalk value resulting from the scaled sum of products in EQ. 3 above may then be converted back into the logarithmic scale. If the crosstalk is separately considered for individual colors, then the pixel value mentioned above refers to brightness in each of the colors, e.g., Red, Blue, Green (which is what is measured when analyzing the values of the cyan, yellow, and magenta dyes, respectively).

### Step 305

In step 305, each pixel considered in step 304 (i.e., each of the plurality of pixels in the projected images for which crosstalk information, e.g., crosstalk value, has been determined) is recorded out to a film negative with a density adjustment to at least partially compensate for crosstalk value that is expected to be present between the projected left- and right-eye images. Specifically, the density of each pixel output from an image in a digital intermediate is determined based on the crosstalk information obtained in step 304 for each pixel, and the density adjustment is applied accordingly to the film medium such that the increased brightness from crosstalk is effectively compensated for (or at least partially reduced) in the film print produced from the negative.

For example, if the crosstalk value for a given pixel from step 304 is expected to be C_{T}, then the density of the pixel output for the film negative should be reduced (i.e., making the film negative brighter or more transparent) by an amount that is a function of C_{T}, such that a film print made from this negative (in step 307 below) will reduce the light output at this pixel by an amount substantially equal to the light increase from the crosstalk value C_{T}. In another embodiment, the reduced density for the pixel in the first image in the film negative is sufficient to at least partially compensate, by a predetermined amount, for the crosstalk contribution values from one or more pixels in the second image.

Thus, the film print will have a corresponding density increase that would reduce the amount of light projected for the given pixel to at least partially compensate for, or substantially equal to the corresponding crosstalk value computed in step 304. The amount of density or intensity adjustment for recording a pixel in the negative can be determined from published sensiometric curves for the negative and print films.

Such curves are substantially linear only in a limited region. For this reason, the algorithms to perform such corrections, well-known in the art, generally employ look-up tables (LUTs) which are empirically created for a given film recorder, negative film stock, and print film stock. A discussion of such LUTs is presented in the April, 2005 edition of American Cinematographer magazine, published by the American Society of Cinematographers of Hollywood, Calif., in an article entitled “The Color-Space Conundrum, Part Two: Digital Workflow”. Some LUTs are published, for example, Eastman-Kodak of Rochester, N.Y. publishes the LUTs for the film stocks it manufactures in their Kodak Display Manager and Look Management System products. Both references are herein incorporated by reference in their entireties.

### Steps 306-309

In step 306, steps 304 and 305 are repeated for other stereoscopic images in the film presentation, e.g., other frames in the film. Although it may be preferable in some situations to perform density adjustments for all images in all frames of the film, it is not required. A film negative (or other alternatives, e.g., digital version of the film images, if desired) may then be prepared based on the density determination results.

In step 307, a film print is made from the film negative prepared in step 306.

In step 308, when the film print from step 307 is projected with system 100, or a similar one, and viewed by audience member 160, the perception of crosstalk is substantially eliminated compared to a film print for which no crosstalk correction has been included.

An exceptional situation can occur where, in the print, the pixel to be adjusted for one eye may already be at a high density (i.e., dark), such that, even at its maximum density (i.e., darkest) is unable to reduce the light further enough to completely offset the crosstalk from the projection of the other-eye image. However, such situations do not occur too often, and are usually brief in duration.

Process 300 concludes at step 309.

The procedure in step 304 is further illustrated by the examples in FIG. 4 and FIG. 5 for determining the crosstalk value at a given pixel of a first stereoscopic image arising from contributions of proximate pixels in the second stereoscopic image.

FIG. 4 shows a region 400 around projected left-eye image pixel 410 (shown as a quadrilateral in bold) with coordinate {x′,y′} designated as L_{(x′,y′)} in FIG. 4 Projected in proximity to left-eye pixel 410 are right-eye image pixels 421-426, each of which (except right-eye pixel 423) partially overlaps left-eye pixel 410.

Left-eye pixel 410 is bounded on the left and right by respective grid lines 411 and 412, and above and below by grid lines 413 and 414, respectively. In this example, grid lines 411 and 413 may be considered to have the coordinate values of x′ and y′, respectively, and the upper-left corner of left-eye pixel 410 is thus designated as L_{(x′,y′)}. Note that the four grid lines 411-414 may not be straight lines over the entirety of projected left-eye image 212. However, at high magnification, their curvature is usually negligible and, at this scale, they will be treated as straight. Note that this {x′,y′} value corresponds to values in the x_{L}, y_{L} coordinate space in the conversion equations EQ. 1 and EQ. 2 above.

Right-eye pixels 421-426 have similar edges with negligible curvature when considered at this scale. Their top-left corners are designated in a different coordinate system from that of pixel 410. For example, right-eye pixel 421 has coordinate {i,j} and is designated as R_{(i,j)}, and right-eye pixels 422-426 have coordinates {i+1, j}, {i+2, j}, {j+1}, {i+1, j+1}, {i+2, j+1}, respectively. These {i,j} coordinates correspond to values in the x_{R}, y_{R} coordinate space in the conversion equations above, and can be converted to x_{L}, y_{L} coordinates as previously described using EQ. 2.

When projected, right-eye pixels 421, 422, 424, 425, and 426 overlap left-eye pixel 410 with corresponding intersections or overlapping regions 431, 432, 434, 435, and 436 (each overlapping region being defined by the corresponding boundaries of the respective right-eye pixels and left-eye pixel 410). Right-eye pixel 423 does not overlap left-eye pixel 410, so there is no corresponding intersecting region.

The sum of the areas from each of the projected overlapping regions 431, 432, 434, 435, and 436 equals the area of projected left-eye pixel 410. The contribution of projected right-eye pixel 421 with respect to left-eye pixel 410 will be the area of overlapping region 431 divided by the projected area of left-eye pixel 410. In other words, the contribution from right-eye pixel 421 to left-eye pixel 410 is given by: the ratio A₄₃₁/A₄₁₀, where A₄₃₁ is the area of overlapping region 431, and A₄₁₀ is the area of the left-eye pixel 410.

When this crosstalk contribution from pixel 421 is multiplied by the value of pixel 421 (where the “value” of pixel 421 corresponds linearly to the brightness of pixel 421 as seen by audience member 160), and subsequently multiplied by the expect crosstalk percentage determined in step 303 for region 400, the result is the apparent increase in brightness of left-eye pixel 410 due to the crosstalk or leakage from right-eye pixel 421. Note that for small angles of keystoning, the area of left-eye pixel 410 will be treated as substantially equal to unity. (In this example, region 400 corresponds to a portion of the screen surrounding the pixel under consideration, e.g., pixel 410, and proximate pixels from the other-eye image, e.g., pixels 421-426.)

Well-known to those skilled in the art, the area of each overlapping region 431, 432, 434, 435 and 436 may be determined by the Surveyor's Formula which, for a polygon of n vertices, produces an area A after their x_{R},y_{R} coordinates have been translated into x_{L},y_{L} coordinates (note that the resulting translated coordinates will rarely be integers), as shown in Equation 4 below.

$$A = \frac{1}{2} {\sum }_{i = 0}^{n - 1} ( {x}_{i} {y}_{i + 1} - {x}_{i + 1} {y}_{i} ) \qquad EQ . 4$$

If a more precise result is needed, the projected pixels of region 400 may be translated into a screen-centric coordinate system (not shown). This translation would be highly dependent upon the geometry of the projection system 100, the theatre into which it is placed, and the adjustments to lens 130. In this case, the area of right-eye pixel 410 should not be considered substantially equal to unity, and should also be calculated with the Surveyor's Formula above.

If there is uncertainty in the determination of the expected differential keystoning and other distortions from step 302, the uncertainty can be applied or taken into account by scaling up the size of left-eye pixel 410. For example, if there is an uncertainty of plus or minus a half pixel, then for the purpose of this calculation, the area contained in pixel 410 should be considered to extend upward by half a pixel in a direction perpendicular to grid line 413, rightward by half a pixel in a direction perpendicular to grid line 412, downward by half a pixel in a direction perpendicular to grid line 414, and leftward by half a pixel in a direction perpendicular to grid line 411. Increasing the size of the pixel 410 has the effect of increasing the size and/or number of the overlapping region(s) with proximate right-eye pixels, which may also result in a change in the relative amounts of crosstalk contributions from the overlapping or proximate pixels. By considering more proximate pixels as contributing to the crosstalk of a given pixel (e.g., pixel 410), an effective blurring or smoothing of the contribution may result, which is consistent with the presence of uncertainty associated with the pixel distortion.

FIG. 5 illustrates another example of determining crosstalk value at a given pixel in a region 500. A projected left-eye image 510 (shown as a rectangle in bold) has coordinate {x′,y′}, which is designated as L_{(x′,y′)}. Projected in proximity to left-eye pixel 510 are right-eye image pixels 521-526, each of which (except right-eye pixels 523 and 526) partially overlaps left-eye pixel 510.

Left-eye pixel 510 is bounded on the left by grid line 511 and above by grid line 513. For this example, grid lines 511 and 513 may be considered to have the coordinate values of x′ and y′, respectively, and the upper-left corner of left-eye pixel 510 is thus designated as L_{(x′,y′)}. Note that grid lines 511 and 513 may not be straight, orthogonal lines over the entirety of projected left-eye image 212. However, at high magnification, their curvature and slope off true vertical and horizontal (respectively) are usually negligible and, at this scale, they will be treated as straight and plumb or horizontal. This {x′,y′} value corresponds to values in the x_{L}, y_{L} coordinate space in the conversion equations above, e.g., EQ. 1 and EQ. 2.

Right-eye pixels 521-526 have similar edges with negligible curvature when considered at this scale. Their top-left corners are designated in a different coordinate system from that of left-eye pixel 510. For example right-eye pixel 521 has coordinate {i,j} and is designated as R_{(i,j)}, and right-eye pixels 522-526 have coordinates {i+1, j}, {i+2, j}, {j+1}, {i+1, j+1}, {i+2, j+1}, respectively. These {i,j} coordinates correspond to values in the x_{R}, y_{R} coordinate space in the above conversion equations, e.g., EQ. 1 and EQ. 2, and can be converted to x_{L}, y_{L} coordinates as previously described.

As shown in FIG. 5, the projected right-eye pixels 521, 522, 524 and 525 overlap left-eye pixel 510 with corresponding intersections or overlapping regions 531, 532, 534 and 535 (each being defined by the corresponding boundaries of the respective right-eye pixel and left-eye pixel 510). Since right-eye pixels 523 and 526 do not overlap left-eye pixel 510, there are no corresponding intersecting regions.

The sum of the areas from each of the projected overlapping regions 531, 532, 534 and 535 equals the area of projected left-eye pixel 510. The contribution of projected right-eye pixel 521 to left-eye pixel 510 is given by the area of overlapping region 531 divided by the projected area of left-eye pixel 510.

When this contribution is multiplied by the value of pixel 521 (where the “value” of pixel 521 corresponds linearly to the brightness of pixel 521 as seen by audience member 160) and further multiplied by the expected crosstalk percentage for region 500 (e.g., determined in step 303), the result is an apparent increase in brightness of left-eye pixel 510 due to the crosstalk contribution value from right-eye pixel 521. Note that FIG. 5 assumes small angles of keystoning, thus the area of left-eye pixel 510 will be treated as substantially equal to unity.

The assumption that the slopes of grid lines such as 511 and 513 and the sides of right-eye pixels 521-526 are substantially vertical and horizontal (i.e., have negligible deviations from vertical and horizontal) make the calculation of crosstalk contribution by overlapping right-eye pixels considerably simpler than otherwise would be. Thus, the contribution of right-eye pixel 521 is proportional to the area of intersection 531, which is the product of (1−the horizontal component of line segment EI)*(1−the vertical component of line segment EI). The horizontal and vertical dimensions of a pixel are treated as unity. Similarly, the contribution of right-eye pixel 522 is proportional to the area of intersection 532, and is the product of (1−the horizontal component of line segment FI)*(1−the vertical component of line segment FI). Similarly, line segments HI and GI can be used for calculating the respective areas of intersections 534 and 535, for right-eye pixels 524 and 525, respectively.

If there is uncertainty in the determination of the expected differential keystoning and/or other distortions from step 302, the magnitude of the uncertainty, e.g., plus or minus one pixel, can be accounted for in the crosstalk calculation by applying a lowpass filter to the other eye image. This is an alternative approach to the “pixel-expansion” approach previously described in connection with FIG. 4. For example, a Gaussian blur may be selected as the basis for a lowpass filter algorithm, and a convolution matrix is built using the magnitude of the uncertainty from step 302 as the standard deviation σ (sigma) component in the following equation.

$$G ( x , y ) = \frac{1}{2 {πσ}^{2}} {e}^{- \frac{{x}^{2} + {y}^{2}}{2 {σ}^{2}}} \qquad EQ . 5$$

In this equation, the coordinates {x,y} represent the offsets in the convolution matrix being computed, and should be symmetrically extended in each axis in both the plus and minus directions about zero by at least 3σ (three times the magnitude of the uncertainty) to obtain an appropriate sized matrix, and though a still larger one may be used for improved accuracy (though the gains diminish rapidly). For example, if the uncertainty (sigma) is plus or minus ½ pixel, then it is recommended to make the matrix extend 3×½, rounded up=2 cells in each direction (up, down, left, right) beyond the central cell, in this case to make a 5×5 matrix. In this convolution matrix, the center cell has {x,y} coordinate of {0,0}, and for a Gaussian blur (as seen from EQ. 5) will have the largest coefficient. One skilled in the art of image processing will understand how to apply this approach to determine crosstalk contribution for a “blurred” pixel at {x,y} (i.e., a pixel with uncertainty in its distortion), based on crosstalk contributions from its unblurred-image neighboring pixels, with diminishing contributions from neighboring pixel that are farther away.

Once the convolution matrix is built, a lowpass-filtered value is determined for each of the other-eye image pixels by applying the convolution matrix such that the filtered value is a weighted average of that other-eye image pixel's neighborhood, with that other-eye image pixel contributing the heaviest weight (since the center value in the convolution matrix, corresponding to {x,y}={0,0} in EQ. 4, is the largest). As before, if the values of other-eye image pixels represent logarithmic values, they must first be converted into a linear representation before this operation is performed. Once the lowpass-filtered values are determined for each other-eye pixel, the values are available for use in the computation of the crosstalk value in step 304 and is used in lieu of the other-eye's pixel value. In this way, contributions from a number of proximal pixels is represented in a single value.

Based on the above discussions, those skilled in the art will recognize these algorithms for determining which other-eye pixels contribute to the crosstalk value at a pixel being considered as being related to algorithms for anti-aliasing, for example, as taught in Newman and Sproul in “Principles of Interactive Computer Graphics: Second Edition”, published by McGraw-Hill College, New York, N.Y., 1978. Subject matter from this reference is incorporated by reference in its entirety. Numerous other implementations can be derived based on the above discussions.

Aside from the dual-lens projection system, various aspects of the present principles can also be applied to synchronized dual film projectors (not shown), in which one projector is used for projecting left-eye images and the other projector is used for projecting right-eye images, each through an ordinary projection lens (i.e., not a dual lens such as dual lens 130). In such a dual projector arrangement, the inter-lens distance 150 would be much greater than a dual-lens single projector system, resulting in substantially greater distortions.

### Digital Projection System

While the above discussion and examples focus on crosstalk compensation for film-based 3D projection, the principles regarding crosstalk contributions from one image to the other image of a stereoscopic pair are equally applicable to certain implementations of digital 3D projection. Thus, features of the present invention for crosstalk compensation or correction can also be applied to certain digital 3D projection systems that use separate lenses or optical components to project the right- and left-eye images of stereoscopic image pairs, in which differential distortions are likely to be present. Such systems may include single-projector or dual-projector systems, e.g., Christie 3D2P dual-projector system marketed by Christie Digital Systems USA, Inc., of Cypress, Calif., U.S.A., or Sony SRX-R220 4K single-projector system with a dual lens 3D adaptor such as the LKRL-A002, both marketed by Sony Electronics, Inc. of San Diego, Calif., U.S.A. In the single projector system, different physical portions of a common imager are projected onto the screen by separate projection lenses.

For example, a digital projector may incorporate an imager upon which a first region is used for the right-eye images and a second region is used for the left-eye images. In such an embodiment, the display of the stereoscopic pair will suffer the same problems of crosstalk described above for film due to the physical or performance-related limitations of one or more components encountered by the light for projecting the respective stereoscopic images.

In such an embodiment, a similar compensation is applied to the stereoscopic image pair. This compensation can be applied to the respective image data either as it is prepared for distribution to a player that will play out to the projector, or by the player itself (in advance or in real-time), by real-time computation as the images are transmitted to the projector, by real-time computation in the projector itself, or in real-time in the imaging electronics, or a combination thereof. Carrying out these corrections computationally in the server or with real-time processing produces substantially the same results with substantially the same process as described above for film.

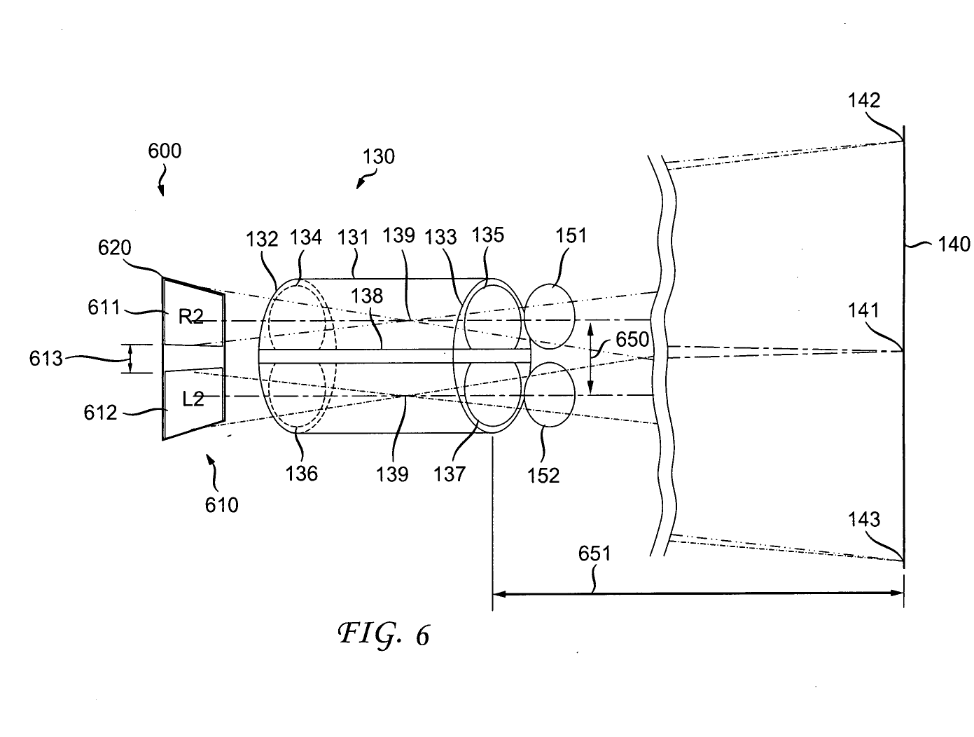

An example of a digital projector system 600 is shown schematically in FIG. 6, which includes a digital projector 610 and a dual-lens assembly 130 such as that used in the film projector of FIG. 1. In this case, the system 600 is a single imager system, and only the imager 620 is shown (e.g., color wheel and illuminator are omitted). Other systems, especially those used in commercial digital cinema exhibition, can have three imagers (one each for the primary colors red, green and blue), and would have combiners that superimpose them optically, which can be considered as having a single three-color imager, or three separate monochrome imagers. In this context, the word “imager” can be used as a general reference to deformable minors display (DMD), liquid crystal on silicon (LCOS), light emitting diode (LED) matrix display, and so on. In other words, it refers to a unit, component, assembly or sub-system on which the image is formed by electronics for projection. In most cases, the light source or illuminator is separate or different from the imager, but in some cases, the imager can be emissive (include the light source), e.g., LED matrix. Popular imager technologies include micro-minor arrays, such as those produce by Texas Instruments of Dallas, Tex., and liquid crystal modulators, such as the liquid crystal on silicon (LCOS) imagers produced by Sony Electronics.

The imager 620 creates a dynamically alterable right-eye image 611 and a corresponding left-eye image 612. Similar to the configuration in FIG. 1, the right-eye image 611 is projected by the top portion of the lens assembly 130 with encoding filter 151, and the left-eye image 612 is projected by the bottom portion of the lens assembly 130 with encoding filter 152. A gap 613, which separates images 611 and 612, may be an unused portion of imager 620. The gap 613 may be considerably smaller than the corresponding gap (e.g., intra-frame gap 113 in FIG. 1) in a 3D film, since the imager 620 does not move or translate as a whole (unlike the physical advancement of a film print), but instead, remain stationary (except for tilting in different directions for minors in DMD), images 611 and 612 may be more stable.

Furthermore, since the lens or lens system 130 is less likely to be removed from the projector (e.g., as opposed to a film projector when film would be threaded or removed), there can be more precise alignment, including the use of a vane projecting from lens 130 toward imager 620 and coplanar with septum 138.

In this example, only one imager 620 is shown. Some color projectors have only a single imager with a color wheel or other dynamically switchable color filter (not shown) that spins in front of the single imager to allow it to dynamically display more than one color. While a red segment of the color wheel is between the imager and the lens, the imager modulates white light to display the red component of the image content. As the wheel or color filter progresses to green, the green component of the image content is displayed by the imager, and so on for each of the RGB primaries (red, green, blue) in the image.

FIG. 6 illustrates an imager that operates in a transmissive mode, i.e., light from an illuminator (not shown) passes through the imager as it would through a film. However, many popular imagers operate in a reflective mode, and light from the illuminator impinges on the front of the imager and is reflected off of the imager. In some cases (e.g., many micro-mirror arrays) this reflection is off-axis, that is, other than perpendicular to the plane of the imager, and in other cases (e.g., most liquid crystal based imagers), the axis of illumination and reflected light are substantially perpendicular to the plane of the imager.

In most non-transmissive embodiments, additional folding optics, relay lenses, beamsplitters, and other components (omitted in FIG. 6, for clarity) are needed to allow imager 620 to receive illumination and for lens 130 to be able to project images 611 and 612 onto screen 140.

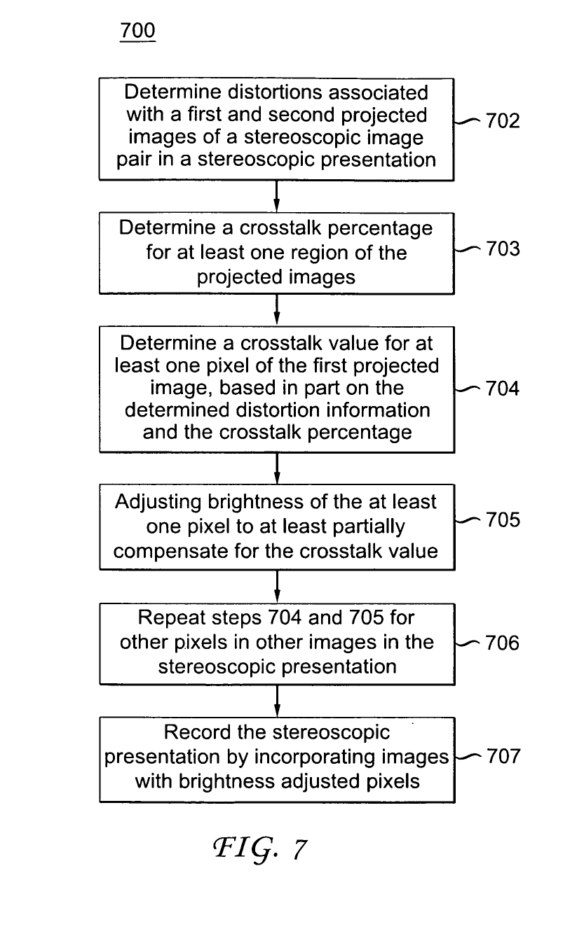

FIG. 7 illustrates another method 700 suitable for performing crosstalk correction in a film or digital file containing a plurality of stereoscopic image pairs for 3D presentation using a film-based or digital projection system, e.g., a dual-lens system or a dual projector system that gives rise to differential distortions in the projected left- and right-eye images. In a projection system such as the over-under lens systems of FIGS. 1 and 6, the stereoscopic image pair is provided within one frame of a film or digital file corresponding to a stereoscopic presentation. Alternatively, in the digital system of FIG. 6, the two images of a stereoscopic pair may be stored separately and dynamically assembled for presentation on the same imager (e.g., 620) at presentation time.

The method includes step 702, in which distortions associated with projected first and second images of a stereoscopic image pair (or differential distortion between the two images) are obtained, e.g., by measurement, estimation or modeling, as previously described in connection with step 302 of FIG. 3.

In step 703, crosstalk percentage for at least one region of the projected first and second images of a stereoscopic pair is determined, e.g., by measurements or estimations, as described in connection with step 303 of FIG. 3. For digital projection systems, similar procedures previously described for the film-based system can be adapted accordingly. In most cases, the crosstalk percentage measured in a region for one image of a stereoscopic pair will be sufficiently equal to that for the other image that only one measured crosstalk percentage is necessary (i.e., X_{T} in EQ. 3 will be substantially the same for each of the left- and right-eye images).

In step 704, the crosstalk value for at least one pixel of the first projected image is determined. In one example, the crosstalk value is determined using EQ. 3. Thus, for a given pixel of the first image (corresponding to one or more selected regions on the screen), the crosstalk value can be determined based on the total crosstalk contributions and the pixel value of a plurality of proximate pixels of the second projected image, as well as the crosstalk percentage determined in step 703 for the applicable region.

In one example, these crosstalk-contributing pixels from the second projected image are sufficiently close or proximate to the given pixel in the first image in projected image space that they share or may share (in the presence of uncertainty) respective overlapping regions with the given pixel in the first image. Similar to the previous discussion in step 304, results from step 702 (i.e., distortions of the stereoscopic images) can be used to establish correspondence among pixels from the two images, e.g., by providing a common coordinate system for pixels of the two images, and allowing the identification of pixels in one image with non-zero crosstalk contributions to the given pixel in the other image. The crosstalk value determination may be performed by obtaining a weighted sum of the crosstalk contributions from one or more pixels of the second image (e.g., pixels proximate to the given pixel of the first image), multiplied by the crosstalk percentage appropriate to the region, similar to that discussed for step 304 of FIG. 3.

In step 705, based on the determined crosstalk value for the at least one pixel in the first image, a density or brightness adjustment (e.g., modification that would result in a change in density of a film print or change in brightness of a pixel in a digital file) is determined for the given pixel of the first projected image. The density or brightness adjustment, which can also be referred to as a brightness-related adjustment, is used to at least partially compensate for the brightness increase resulting from the crosstalk value resulting from pixels in the second image. For example, the density adjustment may be used for recording a film negative at a location corresponding to the pixel in a digital intermediate for the film, such that a film print made from the film negative would result in a corresponding light or brightness decrease in the projected image that at least partially compensate for the brightness increase from the leakage. In one embodiment, the density adjustment is a reduced density amount for the film negative that is substantially equal to the brightness increase expected from the crosstalk. Procedures for step 705 are similar to those described in connection with step 305 of FIG. 3.

In the case of a digital projection system in which a digital image file is used for 3D projection, for a pixel of the first image of the stereoscopic pair, in order to compensate for crosstalk value expected from the second image of the stereoscopic pair, density or brightness adjustment or modification would involve decreasing the brightness of that pixel by an amount about equal to crosstalk value (i.e., brightness increase) expected from the projected second image.

As shown in step 706, steps 704 and 705 are then repeated for additional pixels, or all pixels (if desired), in other images in the film or digital file for the movie presentation. In step 707, a film negative and/or print may then be produced or recorded based on the results of the density adjustments. Alternatively, a data file for digital projection, or for the film or movie presentation containing stereoscopic images with crosstalk compensation may be produced or recorded for later use.

Thus, such a method can result in a crosstalk compensated film or digital file suitable for stereoscopic presentation. In one embodiment, the film or digital file is suitable for use in an over-under projection system is produced, with a plurality of stereoscopic images having density or brightness adjustments to at least partially compensate for crosstalks expected between projected images of stereoscopic pairs having differential distortions when projected by the projection system.

Other embodiments applicable to both film-based and digital projection systems may also involve variations of one or more method steps shown in FIG. 3 and FIG. 7. Thus, instead of determining the expected crosstalk percentage of left- and right-eye images projected on a screen in steps 303 and 703, crosstalk percentage can be measured by projection using a ‘transparent film’ or no film at all, rather than using a film containing a more complex image. For example, a suitable, corresponding projection for a digital or video projector can use an all-white test pattern or an image containing a white field.

In systems such as the film-based or digital projection systems with polarizing filters, the crosstalk from one image to the other image of a stereoscopic pair is expected to be close to symmetrical, i.e., crosstalk from left-eye image to the right-eye image is about the same as the crosstalk from right-eye image to the left-eye image. However, there may be other systems that could have asymmetrical crosstalk between the two images of a stereoscopic pair, e.g., for anaglyphic displays (with red/blue or green/magenta viewing glasses)., in which case, the crosstalk measured in the same region for each of the stereoscopic images may differ from each other.

Furthermore, if there is prior knowledge regarding the distortion associated with a first projected image of a stereoscopic pair, then a distortion measurement for the other (i.e., second) image in step 302 or 702 would be sufficient to allow-the differential distortion to be determined (e.g., without necessarily projecting both images on screen for distortion measurements or determination). Of course, the distortion measurement for the other image has to be made with respect to the known distortion of the first image in order for it to be useful towards determining differential distortion for use in identifying correspondence of a given pixel in one image and its associated, crosstalk-contributing pixels in the other image. Such prior knowledge of distortion may be obtained from experience, or may be computed based on certain parameters of the projection system, e.g., throw distance 651, inter-axial distance 650, among others. However, in the absence of such prior knowledge, measurements on both stereoscopic images would generally be needed in order to arrive at the differential distortion.

Although various aspects of the present invention have been discussed or illustrated in specific examples, it is understood that one or more features used in the invention can also be adapted for use in different combinations in various projection systems for film-based or digital 3D presentations.

While the forgoing is directed to various embodiments of the present invention, other embodiments of the invention may be devised without departing from the basic scope thereof. Thus, the appropriate scope of the invention is to be determined according to the claims that follow.

1. A method for producing a stereoscopic presentation containing a plurality of stereoscopic image pairs for projection by a projection system, comprising:
(a) determining distortion information associated with a first and second projected images of a stereoscopic image pair;
(b) determining crosstalk percentage for at least one region of the projected images of the stereoscopic image pair;
(c) determining a crosstalk value for at least one pixel of the first projected image of the stereoscopic image pair based in part on the determined distortion information and the crosstalk percentage;
(d) adjusting brightness of the at least one pixel to at least partially compensate for the crosstalk value;
(e) repeating steps (c) and (d) for other pixels in other images in the stereoscopic presentation; and
(f) recording the stereoscopic presentation by incorporating images with brightness adjusted pixels.

2. The method of claim 1, wherein the determining of distortion information in step (a) comprises determining a differential distortion associated with the projected images of the stereoscopic pair.

3. The method of claim 2, wherein the determining of distortion information in step (a) comprises performing at least one of measurement, estimation and modeling.

4. The method of claim 1, wherein the determining of the crosstalk percentage in step (b) comprises at least one of measurement and calculation.

5. The method of claim 1, wherein the determining of the crosstalk value in step (c) comprises:
(c1) for a given pixel in the first projected image of the stereoscopic pair, identifying the plurality of pixels in a second projected image, the plurality of pixels being proximate to the given pixel in the first projected image;
(c2) determining crosstalk contributions from the plurality of pixels of the second projected image to the given pixel in the first projected image; and
(c3) determining the crosstalk value for the given pixel based on at least: pixel values of the plurality of pixels of the second projected image, the crosstalk contributions determined in step (c2), and the crosstalk percentage determined in step (b).

6. The method of claim 5, wherein the pixel values used in step (c3) include representations of at least one of brightness, luminance and color of the plurality of pixels.

7. The method of claim 5, wherein step (c1) further comprises:
identifying the plurality of pixels in the second projected image proximate to the given pixel in the first projected image based on distortion information determined from step (a).

8. The method of claim 1, wherein the adjustment for affecting brightness of the at least one pixel in step (d) includes at least one of: adjusting density in a film negative and decreasing luminance of a pixel in a digital file.

9. The method of claim 1, wherein the crosstalk percentage determination in step (b) comprises determining crosstalk percentages for different colors corresponding to dyes used for producing film prints.

10. The method of claim 1, wherein step (f) comprises recording the stereoscopic presentation in at least one of a film medium and digital file.

11. A plurality of stereoscopic images for use in a stereoscopic projection system, comprising:
a first set of images and a second set of images, each image from one of the two sets of images forming a stereoscopic image pair with an associated image from the other of the two sets of images;
at least some images in the first set of images incorporating brightness-related adjustments for at least partially compensating for crosstalk contributions from the associated images in the second set of images;
at least some images in the second set of images incorporating brightness-related adjustments for at least partially compensating for crosstalk contributions from the associated images in the first set of images; and
wherein the crosstalk contributions from respective images in the first and second sets of images are determined based in part on distortion information associated with projection of the stereoscopic images.

12. The plurality of stereoscopic images of claim 11, wherein the crosstalk contribution from an image in the first set of images to the associated image in the second set of images includes pixel-wise crosstalk contributions that are based in part on a spatial relationship between pixels in the projected image of the first set and the projected associated image of the second set.

13. The plurality of stereoscopic images of claim 11, wherein the pixel-wise crosstalk contributions are determined by identifying a plurality of pixels in the projected image from the first set that are proximate to a pixel in the projected associated image from the second set, and determining respective crosstalk contributions from the plurality of pixels in the image from the first set.

14. The plurality of stereoscopic images of claim 13, wherein the plurality of proximate pixels in the image from the first set are identified based on the distortion information associated with projection of the stereoscopic images.
